(19) United States
(12) Patent Application Publication
(10) Pub. No.: US 2024/0145969 A1
(43) Pub. Date: May 2, 2024

(54) Medium Voltage Connector

(71) Applicant: ABB Schweiz AG, Baden (CH)

(72) Inventor: Oliver Claus, Ratingen (DE)

(73) Assignee: ABB Schweiz AG, Baden (CH)

(21) Appl. No.: 18/495,875

(22) Filed: Oct. 27, 2023

(30) Foreign Application Priority Data
Oct. 27, 2022 (EP) 22204024.8

(51) Int. Cl. H01R 13/05; H01R 13/53; H02B 13/045

(52) U.S. Cl. CPC H01R 13/052; H01R 13/53; H02B 13/045

(57) ABSTRACT

A medium voltage connector incudes a flange leg and a cone leg. The flange leg is connected to the cone leg, and a central longitudinal axis of the flange leg is angled to a central longitudinal axis of the cone leg. The flange leg is configured to be connected to a part of a medium voltage switch gear. The cone leg comprises an outer cone connection, and an outer surface of the flange leg comprises an electroconductive coating and/or an outer surface of the cone leg comprises an electroconductive coating.

### CROSS-REFERENCE TO RELATED APPLICATIONS

The instant application claims priority to European Patent Application No. 22204024.8, filed Oct. 27, 2022, which is incorporated herein in its entirety by reference.

### FIELD OF THE DISCLOSURE

The present disclosure relates to a medium voltage connector, and a medium voltage switchgear.

### BACKGROUND OF THE INVENTION

Medium voltage equipment can be connected to gas insulated medium voltage switchgear by inner or outer cone applications. The outer cone bushings are straight bushings that may be of different length with internal field control electrodes. Due to the kind of connectors available in the market the shape of the switchgear compartments for inner and outer cone applications must different.

Typically, the current path of outer cone cable bushings (also called connectors) is straight. To be able to connect the cable plugs from the front, the current path to which the outer cone bushing is electrically connected to has to be led below the bottom of the gas compartment or, depending on the use and design, behind the gas compartment. This can be done by means of elongating a part of the gas compartment in the back downwards or at the rear side backwards. Another design used is to flange a separate (gas) compartment to the bottom or the rear side of the gas compartment which requires additional bushings. At the same time current transformers must be mounted in the current path between the gas compartment and the cable plugs. This can be achieved by steel tubes which belong to the gas compartment and are fitted around the current path to hold the current transformers. Or this can be done by tubes that are fitted outside between two gas compartments to hold the current transformers.

Inner cone cable connectors do not have the same space requirements as outer cone cable connectors do, and therefore the shape of the compartment can be optimized differently to that for a compartment when outer cone connectors are used.

### BRIEF SUMMARY OF THE INVENTION

It would be advantageous to provide a more compact outer cone connector. Embodiments in accordance with the present disclosure describe a medium voltage connector, comprising:
a flange leg; and
a cone leg.

The flange leg is connected to the cone leg. A central longitudinal axis of the flange leg is angled to a central longitudinal axis of the cone leg. The flange leg is configured to be connected to a part of a medium voltage switchgear. The cone leg comprises an outer cone connection. An outer surface of the flange leg comprises an electroconductive coating and/or an outer surface of the cone leg comprises an electroconductive coating.

### BRIEF DESCRIPTION OF THE SEVERAL VIEWS OF THE DRAWING(S)

FIG. 1 is an outline view of an exemplary embodiment of a medium voltage connector in accordance with the disclosure.

FIG. 2 is an outline view of an alternative exemplary embodiment of a medium voltage connector in accordance with the disclosure.

FIG. 3 is an outline view of another alternative exemplary embodiment of a medium voltage connector in accordance with the disclosure.

### DETAILED DESCRIPTION OF THE INVENTION

A new medium voltage connector is now described. The new design is in effect an angle-shaped medium voltage connection device with an outer cone interface, that in one specific embodiment can be termed an L-Bushing.

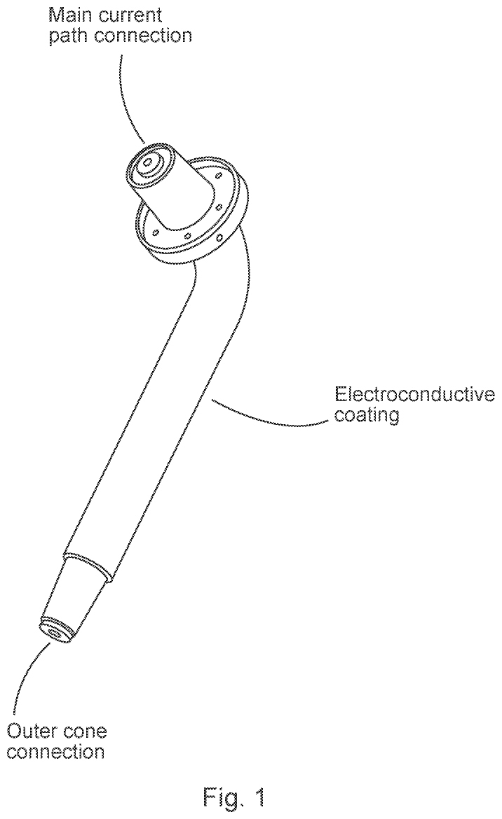

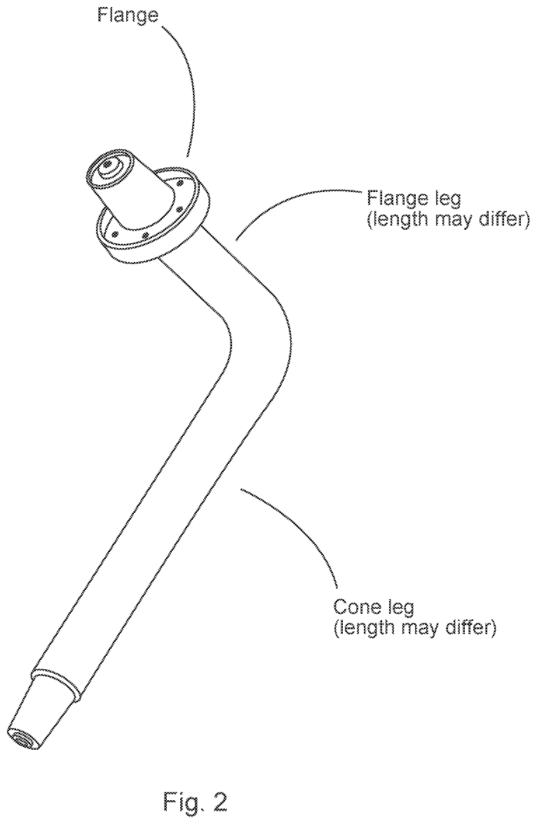

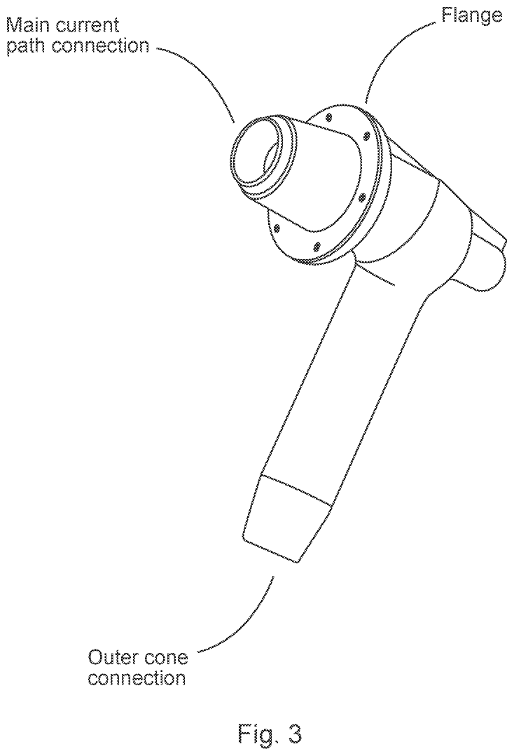

In an example, a medium voltage connector comprises a flange leg and a cone leg. The flange leg is connected to the cone leg. A central longitudinal axis of the flange leg is angled to a central longitudinal axis of the cone leg. The flange leg is configured to be connected to a part of a medium voltage switch gear. The cone leg comprises an outer cone connection. An outer surface of the flange leg comprises an electroconductive coating and/or an outer surface of the cone leg comprises an electroconductive coating. Specific embodiments of the connector, also termed an angled outer cone connection device or bushing, are shown in FIGS. 1, 2, and 3, where it is shown that the flange leg is angled to the cone leg. In this manner, outer cone connections can be utilized in a compact arrangement because the connector or bushing is angled, for example in an L form.

Furthermore, the total length of the connection device can be longer than present designs, the capacity of the field control electrodes for longer bushings can be tuned as required and is reduced compared to present designs, and due to the electroconductive coating on the outside of the bushing a higher dielectric strength can be achieved.

In an example, an outer surface of the flange leg comprises an electroconductive coating and an outer surface of the cone leg comprises an electroconductive coating.

In an example, the flange leg comprises one or more field control electrodes and/or the cone leg comprises one or more field control electrodes.

In an example, the flange leg comprises one or more field control electrodes and the cone leg comprises one or more field control electrodes.

In an example, the one or more field control electrodes of the flange leg are connected to the electroconductive coating on the outer surface of the flange leg and/or the one or more field control electrodes of the cone leg are connected to the electroconductive coating on the outer surface of the cone leg.

In an example, the one or more field control electrodes of the flange leg are connected to the electroconductive coating on the outer surface of the flange leg and the one or more field control electrodes of the cone leg are connected to the electroconductive coating on the outer surface of the cone leg.

In an example, the one or more field control electrodes of the flange leg are configured for voltage signal detection and/or the one or more field control electrodes of the cone leg are configured for voltage signal detection.

In an example, the one or more field control electrodes of the flange leg are configured for voltage signal detection and the one or more field control electrodes of the cone leg are configured for voltage signal detection.

In an example, the outer cone connection of the cone leg is a C-type outer cone for cable connection.

In an example, the outer cone connection of the cone leg is a F-type outer cone for cable connection.

In an example, the cone leg is configured to accommodate a ring core current transformer.

In an example, the central longitudinal axis of the flange leg is angled to the central longitudinal axis of the cone leg at an angle of one of: 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees. Other angles are possible, depending upon design requirements.

In an example, the connector is an L shaped bushing.

In an example, the connector is rated for one of: 630 A, 1250 A, 2000 A, 2500 A.

In an example, the connector is rated for different currents, for example: 500 A, 600 A, 700 A, 800 A, 900 A, 1000 A, 1100 A, 1200 A, 1300 A, 1400 A, 1500 A, 1600 A, 1700 A, 1800 A, 1900 A, 2100 A. 2200 A, 2300 A, 2400 A.

In an example, a length of the flange leg is selected based on a required current rating of the connector.

In an example, a length of the cone leg is selected based on a required current rating of the connector.

A medium voltage switchgear can have one or more of the above angled connectors or bushings. comprising at least one connector according to any of claims 1-12.

In an example, each phase of the switchgear comprises a double connector arrangement.

In this manner, by using two connectors or bushings per phase higher currents can be handled in a more compact form.

In an example, the two connectors are arranged diagonally to one another.

The angled connector is now described in specific detail.

The use of the new angled (e.g. L-type) shape for the outer cone connectors or bushings allows the use of the same gas compartments for inner and outer cone solutions.

By using double outer cone connections per phase gas, compartments for higher currents (above 1250 A, up to 2500 A) can be more compact. Outer cone connections are more cost efficient than inner cone connections and outer cone solutions up to 2500 A are not that common in the market, and the new design is also more compact.

By using L-shaped bushings the compartment for inner and outer cone connections can be the same. The length of each leg of the L-bushing can be varied in either way. Different L-shaped bushings or connectors are shown in FIGS. 1, 2, and 3, but where the angle between the flange leg and the cone leg can be other than 90 degrees—in other words the reference here to an L-shaped connector or bushing relates only to one specific non-limiting example. To manage the increased length of the connectors/bushings a connector/bushing also includes one, two or more field control electrodes, that are either electrically connected with an electroconductive coating on the outside or used for voltage signal detection, and that are located distributed over the length of the bushing.

It is to be noted that in the case of a double bushing/connector solution for higher currents up to 2500 A, the gas compartments can be kept very compact by using a second bushing with a longer leg to the flange (diagonal arrangement of the connections of one phase).

The use of field control electrodes that are connected with an electroconductive coating on the surface of the connection device leads to following advantages:
The total length of the connection device can be longer than current designs.
The capacity of the field control electrodes for longer bushings/connectors can be tuned as required and is reduced compared to present designs.
Due to the electroconductive coating on the outside of the bushing/connector a higher dielectric strength can be achieved.

As shown in FIGS. 1, 2, and 3 the new bushing/connector consists of two main design concepts: (1) an angled, L-type, shape of the bushing, and (2) field control electrodes in combination with electroconductive coating of the outside surface of the bushing.

The total distance of the main current path of the L-bushing is made longer compared to that of a conventional straight outer cone bushing, which causes problems with the conventional method of implementing field control electrodes. The use of field control electrodes, that can be smaller than current electrodes, which are connected to the electroconductive coating on the outside surface of the bushing/connector compensates for the disadvantages of the longer main current path of the L-bushing.

The concept of L-bushing/connector can be used for different applications such as cable bushings, busbar bushings or any other outer cone connection application.

The L-bushing/connector has two legs. One leg with the flange (flange-leg), that is fixed to the gas compartment, and one leg with the outer cone connection (cone-leg). The outer cone size can be adapted to the requirements, typically it will be C-type outer cone for cable connection, or an F-type outer cone for cable connection.

The cone-leg is used to accommodate the ring core current transformers.

The length of the flange-leg can be varied to generate different levels for connection of the outer cone devices.

The bushing can have different current ratings, such as 630 A, 1250 A, 2000 A or 2500 A.

A double bushing arrangement per phase can also be used to achieve higher current ratings, such as two times 1250 A to achieve a 2500 A connection.

With a double bushing/connector arrangement, a compact design of the gas tank can be kept by placing the second bushing diagonally offset in the compartment and elongating the flange-leg to generate a second level to connect the devices. This will reduce the width and therefore the footprint of the feeder compared to designs with straight bushings that are arranged sideways next to each other.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In an example, an outer surface of the flange leg comprises an electroconductive coating and an outer surface of the cone leg comprises an electroconductive coating.

In an example, the flange leg comprises one or more field control electrodes and/or wherein the cone leg comprises one or more field control electrodes.

In an example, the one or more field control electrodes of the flange leg are connected to the electroconductive coating on the outer surface of the flange leg and/or the one or more field control electrodes of the cone leg are connected to the electroconductive coating on the outer surface of the cone leg.

In an example, the one or more field control electrodes of the flange leg are configured for voltage signal detection and/or wherein the one or more field control electrodes of the cone leg are configured for voltage signal detection.

In an example, the outer cone connection of the cone leg is a C-type outer cone for cable connection.

In an example, the outer cone connection of the cone leg is a F-type outer cone for cable connection.

In an example, the cone leg is configured to accommodate a ring core current transformer.

In an example, the central longitudinal axis of the flange leg is angled to the central longitudinal axis of the cone leg at an angle of one of: 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees

In an example, the connector is an L shaped bushing.

In an example, the connector is rated for one of: 630 A, 1250 A, 2000 A, 2500 A.

In an example, a length of the flange leg is selected based on a required current rating of the connector.

In an example, a length of the cone leg is selected based on a required current rating of the connector.

In a second aspect, there is provided a medium voltage switchgear comprising at least one connector according to the first aspect or any of the examples relating to the first aspect.

In an example, each phase of the switchgear comprises a double connector arrangement.

In an example, the two connectors are arranged diagonally to one another.

The above aspects and examples will become apparent from and be elucidated with reference to the embodiments described hereinafter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A medium voltage connector, comprising:
a flange leg; and
a cone leg;
wherein the flange leg is connected to the cone leg;
wherein a central longitudinal axis of the flange leg is angled to a central longitudinal axis of the cone leg;
wherein the flange leg is configured to be connected to a part of a medium voltage switch gear;
wherein the cone leg comprises an outer cone connection; and
wherein an outer surface of the flange leg comprises an electroconductive coating and/or an outer surface of the cone leg comprises an electroconductive coating.

2. The medium voltage connector according to claim 1, wherein an outer surface of the flange leg comprises an electroconductive coating and an outer surface of the cone leg comprises an electroconductive coating.

3. The medium voltage connector according to claim 1, wherein the flange leg comprises one or more field control electrodes and/or wherein the cone leg comprises one or more field control electrodes.

4. The medium voltage connector according to claim 3, wherein the one or more field control electrodes of the flange leg are connected to the electroconductive coating on the outer surface of the flange leg.

5. The medium voltage connector according to claim 3, the one or more field control electrodes of the cone leg are connected to the electroconductive coating on the outer surface of the cone leg.

6. The medium voltage connector according to claim 3, wherein the one or more field control electrodes of the flange leg are configured for voltage signal detection.

7. The medium voltage connector according to claim 3, wherein the one or more field control electrodes of the cone leg are configured for voltage signal detection.

8. The medium voltage connector according to claim 1, wherein the outer cone connection of the cone leg is a C-type outer cone for cable connection or a F-type outer cone for cable connection.

9. The medium voltage connector according to claim 1, wherein the cone leg is configured to accommodate a ring core current transformer.

10. The medium voltage connector according to claim 1, wherein the central longitudinal axis of the flange leg is angled to the central longitudinal axis of the cone leg at an angle of one of: 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, or 120 degrees.

11. The medium voltage connector according to claim 1, wherein the connector is an L shaped bushing.

12. The medium voltage connector according to claim 1, wherein the connector is rated for one of: 630 A, 1250 A, 2000 A, or 2500 A.

13. The medium voltage connector according to claim 1, wherein a length of the flange leg is configured based on a required current rating of the connector.

14. The medium voltage connector according to claim 1, wherein a length of the cone leg is configured based on a required current rating of the connector.
